(19) United States
(12) Patent Application Publication
(10) Pub. No.: US 2007/0107229 A1
(43) Pub. Date: May 17, 2007

(54) In the invention elements to offered to shave, improved, that offers the user permanent illumination, using of lamps by eliminating the proper shadow of the shaving element and the shadow of the user

(76) Inventor: Lisandro Claudio Ribal, Santiago (CL)

Correspondence Address: Ms. Pilar Ribal, P.O. Box 37503, San Juan, PR, 00937, US

(21) Appl. No.: 11/416,916

(22) Filed: May 3, 2006

Related U.S. Application Data
(60) Provisional application No. 60/676,852, filed on May 3, 2005.

(51) Int. Cl. B26B 19/00

(52) U.S. Cl. 30/34.05

(57) ABSTRACT

Shaver or razor, one that offers an incorporated lamps light at the same time in its structure. The finished structure of shaver, preferably to the far end of the handle and before the end the arm or extension of the shaving head which holds the shaving blades, will accommodates a lamps, that it is connected to an electric circuit that it's distributed along the inner structure of the handle of shaver connecting to the power source that it will be a battery, and that provided by a switch will turn on and off the indicated lamps. When the lamp is turned on its light offers the user permanent illumination to the surface that it is being shaved, eliminating the proper shadows of the shaving element and the shadows of the user.

In actuality the manual shavers or razors are conformed by an extended handle and, a head positioned perpendicularly to the handle affixed to its middle part, holding the razor blades. The electric type ones are conformed generally by a compact body and usually has the shaving knives in one of its ends.

The common use of the shaver or the manual razor, in generally presents the user with a visual deficiency when it display its shadow over the surface that is going to be shaved and does not contribute with a better visual condition to already shaved surface. The actual shaving elements do not offer a solution to the indicated aspects or problems.

In actuality, the diverse models of shavers or manual razors, are built with different options; the shaving blades have been affixed to pivoting or flexible heads so they may adapt to the irregularities of the surface being shaved, they have two or three blades, the edges of the blades have alloy of different metals to smoothen the shave of the hair and may also incorporate conditioning materials affixed that dissolve with water impregnating the surface being shaved to smoothen the pass of the edge of the blade through the skin.

The electric type ones include pivoting heads so they adapt to the irregularities of the surface being shaved and also have different speeds and cycles of actions for the shaving knives. Also in general, the physical aspects of these machines look for better and improved ways to make them more maneuverable.

All this applications are directed to the conformation of the shavers of razors and to the inclusions of new elements that improve the shave of the hand held razors or shavers; however they omit to improve the existing conditions, such as adequate illumination, in order to offer better vision to the user.

### SPECIFICATION

In the present Invention an element is offered to shave, improved, that offers the user permanent illumination to the surface that it is being shaved, using of lamps or bulbs, by eliminating the proper shadows of the shaving element and the shadows of the user.

This equipment is constituted by three parts or bodies, which by being independent from one another; they can be removed for cleaning or replacement when their useful cycle has reached the end.

This can be performed by the simple process of assembly and manual disassembly. This solution of three independent bodies, is constituted by Body #1 that consist of a principal cylinder, that is the handle of the shaving element, that on its extreme superior end that finishes with a enclosed extension of a narrower diameter that of his own body that its is connected by the way of pressure to a center opening situated at the inferior end of Body #2, that corresponds to the arm or extension of the shaving head which holds the shaving blades. On the base of the indicated centered extension of Body #1, situated on its sides are, there are to smaller openings in which two bulbs are inserted that emit light illuminating the surface under and over the shaving head holding the shaving blades.

The lamps are installed in an electric circuit, by the means of a connection that runs through the interior of the principal cylinder or handle that obtains its electrical power from batteries that are fixed in the interior of said cylinder.

The subsequent extreme part of Body #1 or handle possesses a full diameter opening with a threaded interior annular inferior portion that allows the insertion of the batteries which rest on a metallic segment affixed to the superior internal end of the handle. This metallic segment is connected to a cable that connects to the two lamps that are in the smaller opening situated at both end of the base of the extension that its centered in the end of the handle. The two lamps connects emit light illuminating to the surface that it is being shaved.

Body #2 is constituted by the head that holds the saving blades, that could be of the removable type, it is affixed to the handle by the way of pressure or screw on to a base which has and opening on its center, that fits with the centered extension of a smaller diameter of the handle or Body #1.

The Body #3 corresponds to the cap or lid of the lower extreme end of Body #1 or handle, carrier of the battery. The body #3 possesses a external annular threaded end that screws on to the internal annular threaded end of the handle or Body #1.

The cap or Body #3, in its interior face possesses in its surface a flat metallic plaque, with a lateral extension, the surface plaque makes contact with the negative pole of the inserted battery, and with the lateral extension makes contact with a cable in the interior side of the principal cylinder or handle that connects the lamps to the positive side of the battery, this cap also has the function of opening and closing the electrical system and illumination.

To better explain this invention a description with preference of figures will be shown where:

FIG. #1 shows a view of the equipment put together, ready to be utilized.

FIG. #2 shows a detailed view of the invention in an axial cut.

FIG. #3 shows in detail Body #1.

FIG. #4 shows in detail Body #3.

FIG. #5 shows in detail Body #2.

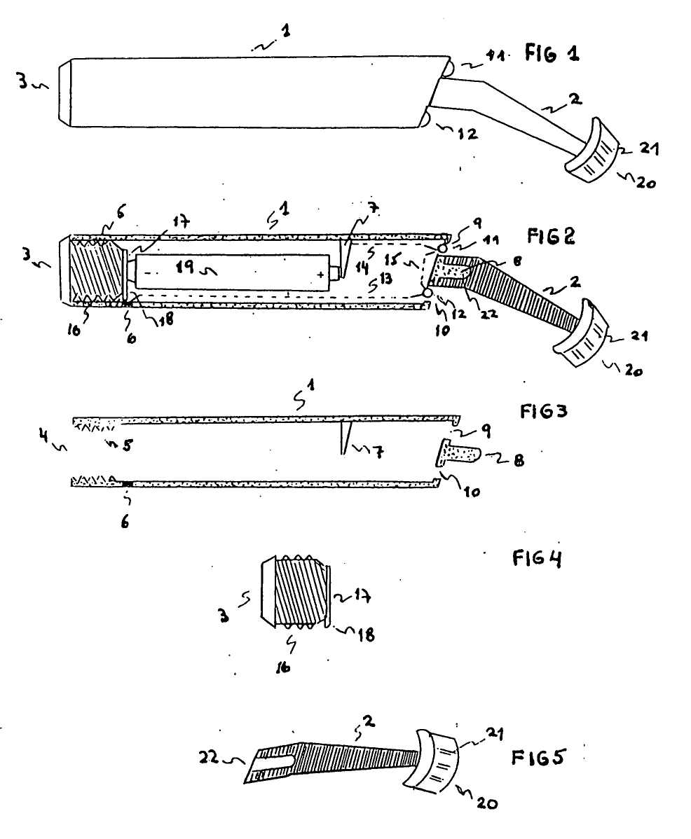

As you can appreciate in FIGS. 1 to 5, the invention consists of an improved shaving apparatus, which possesses three bodies that compose the equipment.

The principal part 1, which is the handle, which is an interior cylindrical, possesses in its lower extreme an opening 4 with an interior threaded annular portion 5 which from and its interior edge, possess a metallic segment 6, over to its opposite prior end and its internal part it possesses a metallic segment 7.ln this same end yet in its exterior part and with a smaller diameter than the principal part it has a centered extension 8 which on its base and positioned on a lateral way, there are two smaller circular openings 9 and 10 in with two small bulbs 11 and 12 are inserted, which are connected trough the cable 13 to the metallic segment 6 and with the cable 14 to the metallic segment 7, from the electric circuit 15.

Body #3 is the lid for Body #1, it possess a threaded annular exterior portion 16 which its end is covered by a metallic surface 17, with has a lateral extension 18.

Thru the opening 4 of the Principal component, Body #1, the battery is inserted 19 which makes contact with its positive pole on segment 7, mean while the negative pole settles on the metallic surface 17 when you screw Body #3 into the opening 4. When moving the lateral extension 18 towards the metallic segment 6 it makes contact and it closes the electrical circuit 15 allowing the lamps, 11 and 12, to be turned on; the reverse process turns them off.

Body #2 holds the razor's shaving blades, which in its top end possesses an extension 20 which has the shaving blades 21 and in its lower end has a centered circular opening 22 in which the centered extension 8 of Body #1 is inserted by the way of pressure, allowing the assembly of this to Bodies.

1. Machine to shave with a light bulb, constituted by a cylindrical handle or container which closes at one end by a cover screwed, which possesses in its interior a battery that feeds two bulbs located in the upper part on this handle; this is connected by pressure to an extension carrying of the shaving blades CHARACTERIZED because the cylindrical container has an open end that allows the batteries to be inserted which are connected to a metallic unit located at the inner side on one of the ends. This unit acts like first electrical contact and also there is a metallic unit of smaller diameter in the superior/opposite end that acts like the second electrical contact. In this same superior end, there are two openings, each one located laterally in the base of an extension of smaller diameter than the body of the cylindrical container. There are two bulbs inserted, one at each opening, on an angular position with relation to the base of the handle. These are connected to the electrical circuit located inside the handle by means of two cables, one that connects the bulbs with the first metallic segment and other that connects the bulbs with the second metallic segment, turning on and off these bulbs through an inserted switch located on the lid which has a metallic base with a lateral extension, and when rotating the cover the metallic base makes contact with the positive pole of the battery and with the first metallic segment, closing this way the circuit, which deactivates when rotating the cover to the opposite side.
